(19) United States
(12) Patent Application Publication
(10) Pub. No.: US 2005/0091049 A1
(43) Pub. Date: Apr. 28, 2005

(54) Method and apparatus for reduction of musical noise during speech enhancement

(76) Inventors: Rongzhen Yang, Shanghai (CN); Michael Deisher, Hillsboro, OR (US)

Correspondence Address: FISH & RICHARDSON, PC, 12390 EL CAMINO REAL, SAN DIEGO, CA, 92130-2081, US

(21) Appl. No.: 10/696,460

(22) Filed: Oct. 28, 2003

(51) Int. Cl. G10L 21/00

(52) U.S. Cl. 704/226

(57) ABSTRACT

Systems and techniques to reduce noise in audio information. According to an aspect, the technique includes determining a speech-presence-uncertainty metric based on input representing audio information, and performing smoothing during noise suppression of the input information based on the determined speech-presence-uncertainty metric to produce output representing audio information with enhanced speech and reduced musical noise. According to another aspect, the system includes speech presence uncertainty assessment circuitry that determines a speech-presence-uncertainty metric based on input audio information and filter coefficients, and smoothing circuitry including a filter (e.g., a low-pass filter) coupled to receive the filter coefficients and a multiplier unit coupled to receive the input audio information and output filter coefficients from the filter. The speech-presence-uncertainty metric may be a full band minimum mean square error estimator weighting, and the filter coefficients may be formulated as a component-wise multiplication of a noisy speech spectrum in a frequency domain.

### BACKGROUND

The present application describes systems and techniques relating to reducing noise in audio signals, for example, reducing musical noise in audio data during speech enhancement processing.

Speech enhancement techniques have been used to improve degraded audio in many applications, including mobile communications. Such techniques include those based on minimum mean square error (MMSE) estimation. Traditional MMSE estimation based techniques include spectral subtraction, Wiener filtering and Ephraim-Malah noise suppression.

### DRAWING DESCRIPTIONS

FIG. 1 is a block diagram illustrating a speech enhancement system.

FIG. 2 is a block diagram illustrating a back-end smoothing system.

FIG. 3 is a flowchart illustrating speech enhancement using a speech-presence-uncertainty metric.

FIG. 4 is another flowchart illustrating speech enhancement using a speech-presence-uncertainty metric.

FIG. 5 is a block diagram illustrating a back-end smoothing system.

FIG. 6 illustrates example results of FFT/IFFT low-pass filtering to realize the smoothing effect.

FIGS. 7-9 are flowcharts illustrating example techniques implementing a hard decision embodiment of a back-end smoothing system.

FIG. 10 is a flowchart illustrating low-pass filtering using FFT/IFFT.

FIG. 11 illustrates a frequency response of an FIR filter.

FIG. 12 is a block diagram illustrating an example mobile data processing machine with speech enhancement.

Details of one or more embodiments are set forth in the accompanying drawings and the description below. Other features and advantages may be apparent from the description and drawings, and from the claims.

### DETAILED DESCRIPTION

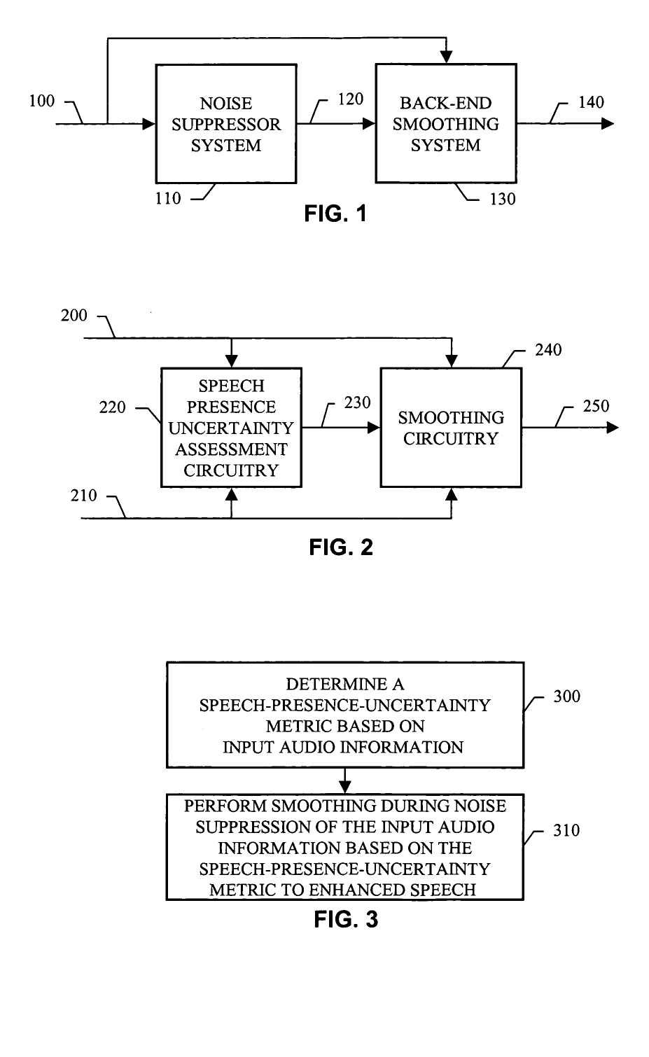

FIG. 1 is a block diagram illustrating a speech enhancement system. A noise suppressor system 110 may receive input 100 representing audio information and generate filter coefficients 120. The input information 100 may represent a source of noisy speech data, either received directly from a microphone or from another system component. The noise suppressor system 110 may generate the filter coefficients 120 to be used in noise reduction, and the filter coefficients 120 may be formulated as a component-wise multiplication of a noisy speech spectrum in a frequency domain.

The noise suppressor system 110 may be a minimum mean square error (MMSE) estimator. For example, the noise suppressor system 110 may employ spectral subtraction, Wiener filtering, and/or Ephraim-Malah noise suppression techniques. While MMSE techniques may differ in how the filter coefficients are computed and the assumptions used, they may be formulated as a component-wise multiplication of the noisy speech spectrum by a set of filter coefficients in the frequency domain.

A back-end smoothing system 130 may receive the input information 100 and the filter coefficients 120. The back-end smoothing system 130 may determine a speech-presence-uncertainty metric based on the input information 100 and the generated filter coefficients 120. The back-end smoothing system 130 may perform smoothing during noise suppression of the input information 100 based on the determined speech-presence-uncertainty metric to produce output 140 representing audio information with enhanced speech. The output 140 may be the final processed speech data or may be input to further processing units.

The output 140 may have reduced tonal residual noise known as musical noise. The back-end smoothing system 130 may add resilience to a speech enhancement system by reducing musical noise that might otherwise be exhibited, such as when the assumptions underlying the technique employed in the noise suppressor system 110 are violated, and/or when there are large instantaneous errors in a noise spectral estimate used to implement MMSE techniques. A large instantaneous error in the noise spectral estimate may lead to large instantaneous deviations in the MMSE estimator's filter coefficients, which might consequently lead to large instantaneous deviations in the processed speech spectrum without the back-end smoothing system 130 in place.

The described speech enhancement systems and techniques may eliminate the musical noise phenomenon by smoothing over brief spikes in the processed speech spectrum and reducing bursts of tonal noise in the time domain. These speech enhancement systems and techniques may reduce musical noise more effectively than a stand alone Ephraim-Malah system, where less aggressive noise suppression can result in tonal artifacts being masked by residual noise, but the noise floor cannot be reduced beyond a predefined threshold without making the residual noise audible. The present speech enhancement systems and techniques may provide significant reduction of noise, enhancing speech without introducing the musical residual noise typically associated with traditional techniques that alter a suppression curve during noise suppression, and without speech distortion that might otherwise be caused by accounting for musical noise during noise suppression.

FIG. 2 is a block diagram illustrating a back-end smoothing system. The back-end smoothing system may include speech presence uncertainty assessment circuitry 220 and smoothing circuitry 240. The speech presence uncertainty assessment circuitry 220 may be coupled to receive input 200 representing audio information, and filter coefficients 210. The speech presence uncertainty assessment circuitry 220 may determine a speech-presence-uncertainty metric 230 based on the received audio information 200 and the filter coefficients 210.

The smoothing circuitry 240 may include a low-pass filter and a multiplier unit, where the low-pass filter is coupled to receive the filter coefficients 210, and the multiplier unit is coupled to receive the audio information 200 and output filter coefficients from the low-pass filter. The speech-presence-uncertainty metric may be based on a full band minimum mean square error estimator weighting, such as a speech presence likelihood generated by an MMSE speech energy estimator, and the filter coefficients may be filter coefficients formulated as a component-wise multiplication of a noisy speech spectrum in a frequency domain. The speech presence uncertainty assessment circuitry 220 may output a metric 230 that is a number between zero and one, inclusive, that takes on a higher value when the presence of speech is unclear.

The smoothing circuitry 240 may use the metric 230 as an indication that musical noise is likely to be present. When speech presence uncertainty is high, the smoothing may be employed to reduce any musical noise. The decision regarding smoothing may be a soft or a hard decision in the circuitry; thus the metric 230 may be a continuous value or a Boolean value. In a hard decision embodiment, fixed smoothing may be applied when the speech presence uncertainty exceeds a threshold. In a soft decision embodiment, a variable amount of smoothing may be applied depending on the level of speech presence uncertainty.

FIG. 3 is a flowchart illustrating speech enhancement using a speech-presence-uncertainty metric. The speech-presence-uncertainty metric may be determined based on input representing audio information at 300. Smoothing during noise suppression of the input information may be performed based on the determined speech-presence-uncertainty metric to produce output representing audio information with enhanced speech at 310.

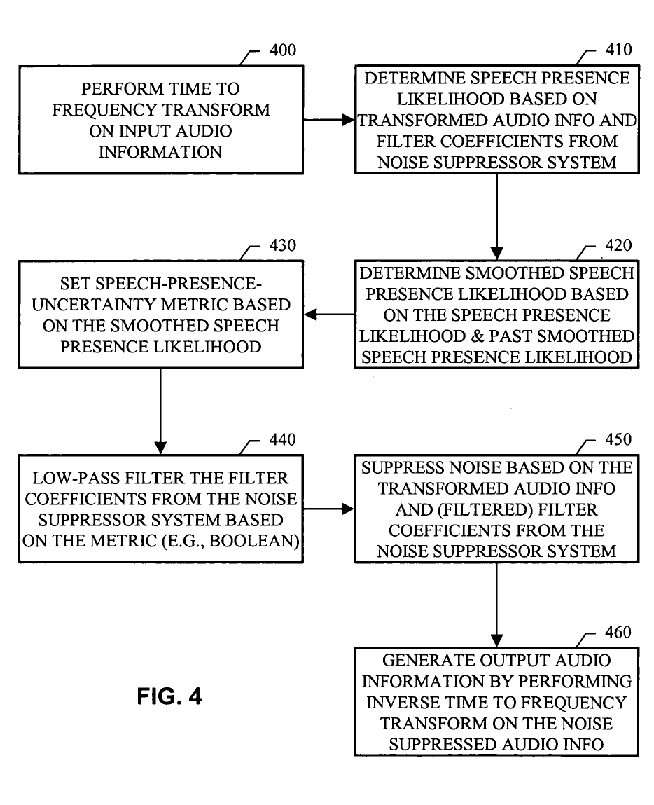

FIG. 4 is another flowchart illustrating speech enhancement using a speech-presence-uncertainty metric. A time to frequency transform may be performed on the input information at 400. A speech presence likelihood may be determined based on the input information (e.g., the transformed information) and filter coefficients from a noise suppressor system at 410. A smoothed speech presence likelihood may be determined based on the determined speech presence likelihood and a past smoothed speech presence likelihood at 420. A speech-presence-uncertainty metric may be set based on the determined smoothed speech presence likelihood at 430.

Additionally, the filter coefficients from the noise suppressor system may be low-pass filtered based on the speech-presence-uncertainty metric at 440. Noise in the input information may be suppressed based on the transformed audio information and the filtered filter coefficients at 450. Output information may be generated by performing an inverse time to frequency transform on the noise suppressed information at 460.

The speech-presence-uncertainty metric may be a Boolean value, the low-pass filtering may involve selectively low-pass filtering the filter coefficients based on the Boolean value, and suppressing the noise may involve suppressing the noise based on the selectively filtered filter coefficients. Thus, the filter coefficients may be filtered to realize the smoothing effect when the Boolean metric is one, and the filter coefficients may not be filtered (or an unfiltered version may be used) when the Boolean metric is zero.

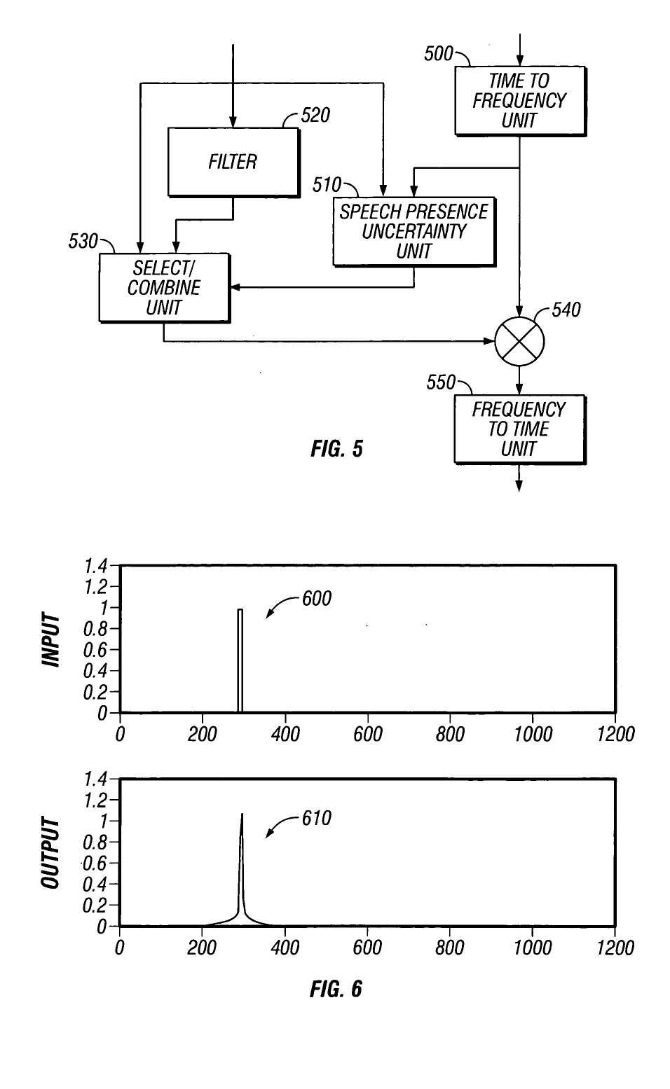

FIG. 5 is a block diagram illustrating a back-end smoothing system. The back-end smoothing system may include a time to frequency unit 500 that transforms input representing audio information. The time to frequency transform implemented by the unit 500 can be a Discrete Fourier Transform (DFT) and/or a Fast Fourier Transformation (FFT). Alternatively, the time to frequency transform implemented by the unit 500 can be a Direct Cosine Transform (DCT) or a Discrete Wavelet Transform (DWT). Other transforms are also possible, and a frequency to time unit 550 may also be included. The unit 550 may implement the inverse transform of the unit 500, such as iDFT(iFFT), iDCT or iDWT, to an output of a multiplier unit 540.

A speech presence uncertainty unit 510 may receive the transformed input information from the unit 500 and also receive filter coefficients, such as described above. The unit 510 may determine a speech-presence-uncertainty metric from these inputs and provide the metric to a select and/or combine unit 530. A filter 520 may also receive the filter coefficients and realize the smoothing effect.

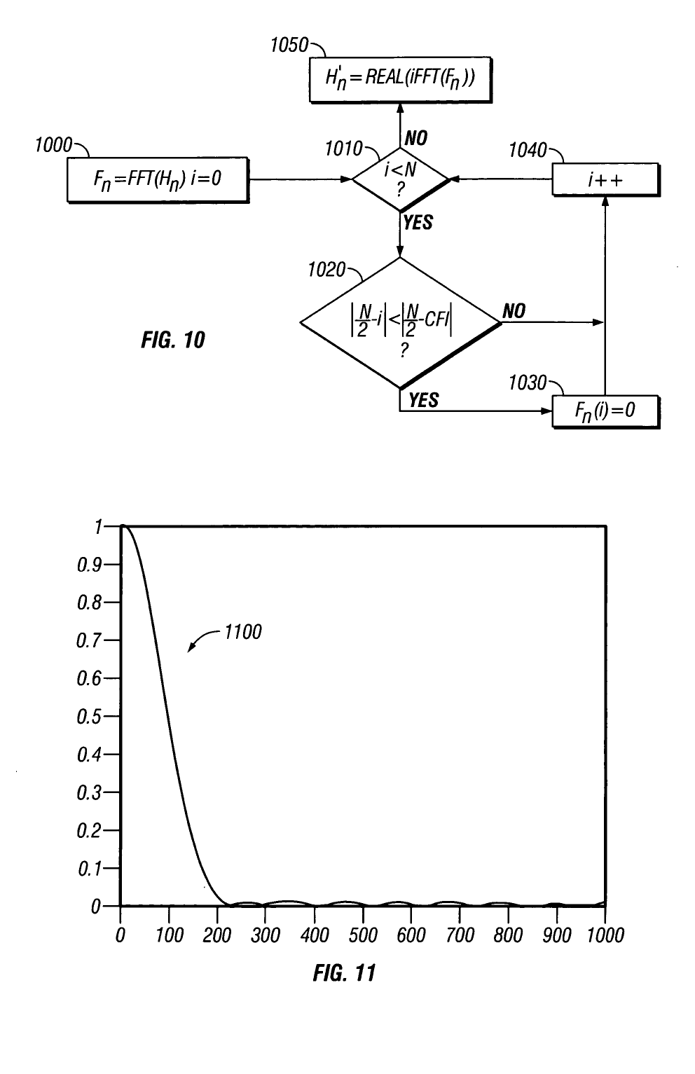

The filter 520 may be a low-pass filter, such as a Finite Infinite Response (FIR) filter, an Infinite Impulse Response (IIR) filter, or an FFT/IFFT filter (e.g., a circulant FIR filter). For example, the input to an FFT unit in an FFT/IFFT filter can be the set of filter coefficients corresponding to a current block of input speech data. The FFT unit outputs to an IFFT unit, and the frequency bins that are index k bigger than a threshold T may be cleared to zero. This is described in further detail below in connection with FIG. 10.

FIG. 6 illustrates example results of FFT/IFFT low-pass filtering to realize the smoothing effect. An input waveform 600 is processed by the FFT/IFFT and generates an output waveform 610. As can be seen, the filter 520 may generate a smoothing effect, and the new filtered filter coefficients can be used to enhance speech in the input audio information.

Referring again to FIG. 5, the select and/or combine unit 530 may be a mulitplexer. The select and/or combine unit 530 may implement the hard or soft decisions described above. Alternatively, the filter 520 may be implemented such that the filtering itself is directly adjusted based on the metric generated by the speech presence uncertainty unit 510, such as a filter that selectively turns on an off based on a Boolean speech-presence-uncertainty metric.

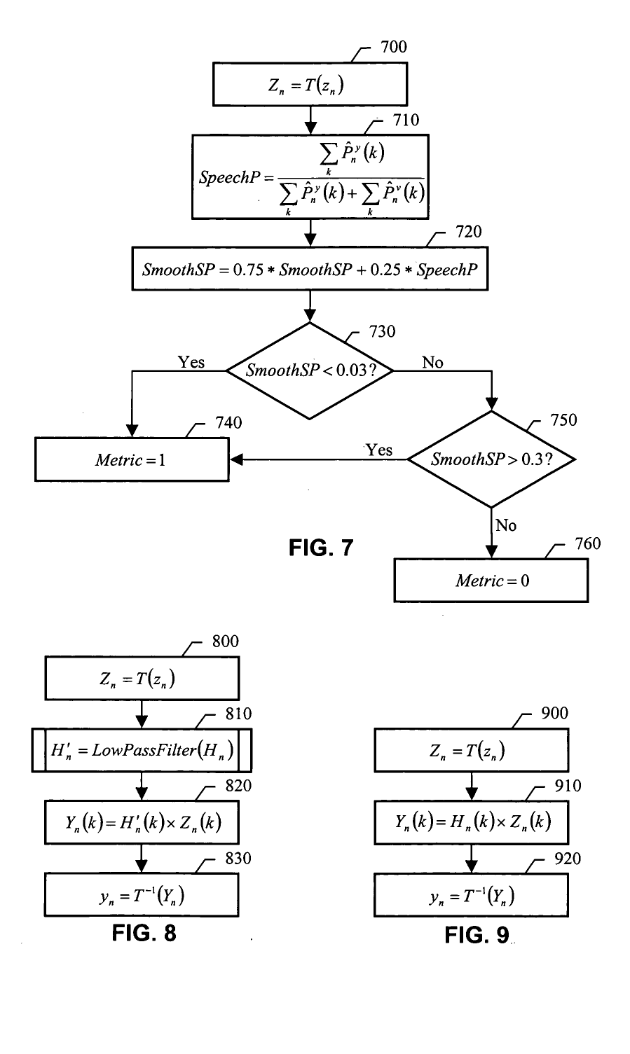

FIGS. 7-9 are flowcharts illustrating example techniques implementing a hard decision embodiment of a back-end smoothing system. FIG. 7 illustrates a speech/pause uncertainty assessment. A time to frequency transform, Zₙ=T(zₙ), is performed at 700. A speech presence likelihood may be calculated at 710:

$$SpeechP = \frac{{\sum }_{k}^{} {\hat{P}}_{n}^{y} ( k )}{{\sum }_{k}^{} {\hat{P}}_{n}^{y} ( k ) + {\sum }_{k}^{} {\hat{P}}_{n}^{v} ( k )}$$

where P^{y} denotes the power spectrum of the clean speech, P^{v} denotes the power spectrum of the noise, and the “\hat{ }” symbol above a quantity indicates that the quantity can be an estimate and need not be the true quantity. For example, \hat{P}^{y} can be an estimate of the clean speech power spectrum.

The equation above for calculating speech presence likelihood is also an estimator weighting in the sense that if one solves for the MMSE estimator weighting of the full-band speech energy (under some assumptions), the solution is SpeechP*Sum(|Z(k)|*|Z(k)|). The input parameters, zₙ and Hₙ, may be vectors of length n, where zₙ is the current (n^{th}) frame of original noisy speech data, and Hₙ is the filter coefficients of the current frame generated by a noise suppressor system.

A smoothed speech presence likelihood may be recalculated at 720:
SmoothSP=0.75*SmoothSP+0.25*SpeechP.
   SmoothSP represents the smoothed speech presence likelihood of passed frames, and may be initialized to zero when the system starts up. If SmoothSP is less than a first threshold (e.g., 0.03) or greater than a second threshold (e.g., 0.3), this may be determined at decisions 730, 750, and a Boolean speech-presence-uncertainty metric may be set to one at 740. Otherwise, the Boolean speech-presence-uncertainty metric may be set to zero at 760.

A metric value of one means that musical noise is likely, and the smoothing operation may be employed. A metric value of zero means that musical noise is not likely, and the smoothing operation need not be employed. FIG. 8 illustrates the smoothing operation. A time to frequency transform, Zₙ=T(zₙ), may be performed at 800. Low-pass filtering of the filter coefficients, H′ₙ=LowpassFilter(Hₙ), may be performed at 810. This low-pass filtering may be realized by many approaches, including the FFT/IFFT and FIR approaches described below. Noise may be suppressed using the filtered filter coefficients, Y′ₙ(k)=H′ₙ(k)×Zₙ(k), at 820; where×stands for component-wise multiplication. Output data frames with musical noise reduced may be generated using a frequency to time transform, yₙ=T⁻¹(Yₙ), at 830.

FIG. 9 illustrates generating the output without the smoothing operation. A time to frequency transform, Zₙ=T(zₙ), may be performed at 900. Noise may be suppressed using the unfiltered filter coefficients, Yₙ(k)=Hₙ(k)×Zₙ(k), at 910. Output data frames may be generated using a frequency to time transform, yₙ=T⁻¹(Yₙ), at 930.

FIG. 10 is a flowchart illustrating low-pass filtering using FFT/IFFT. N may be the length of input data frames and may be selected as 2ⁿ, such as 64, 128, or 256. Fₙ may be set as the Fast Fourier Transform of Hₙ, with i set to zero, at 1000. While i is less than N at decision 1010, a check is made at 1020 based on the inequality:

$$\vert \frac{N}{2} - i \vert < \vert \frac{{N}^{′}}{2} - CFI \vert .$$

CFI is the cutoff frequency index, which may be N/16, and CFI may also vary in different implementations. When the inequality is true, Fₙ(i) may be set to zero at 1030; i may be incremented at 1040 regardless.

Once i is no longer less than N, H′ₙ may be set equal to real(iFFT(Fₙ)) at 1050. The result of FFT or iFFT may be a vector of complex value, which is composed by a real number part and an imaginary number part. Thus, the real( ) function may select the real part from the complex value.

As mentioned above, the low-pass filter may also be implemented using a FIR filter. In this case, H′ₙ may be set equal to the convolution of the FIR smoothing filter coefficients and the noise reduction filter coefficients: FIR [symbol] Hₙ. The FIR may be defined as follows:

FIR( ) = {

0.00816236022656, 0.01099310832930, 0.01914373773964,
0.03163148730838, 0.04695032724357, 0.06325262352735,
0.07857202260246, 0.09106066635055, 0.09921211743408,
0.10204309847622, 0.09921211743408, 0.09106066635055,
0.07857202260246, 0.06325262352735, 0.04695032724357,
0.03163148730838, 0.01914373773964, 0.01099310832930,
0.00816236022656
}

FIG. 11 illustrates a frequency response 1100 of the FIR smoothing filter.

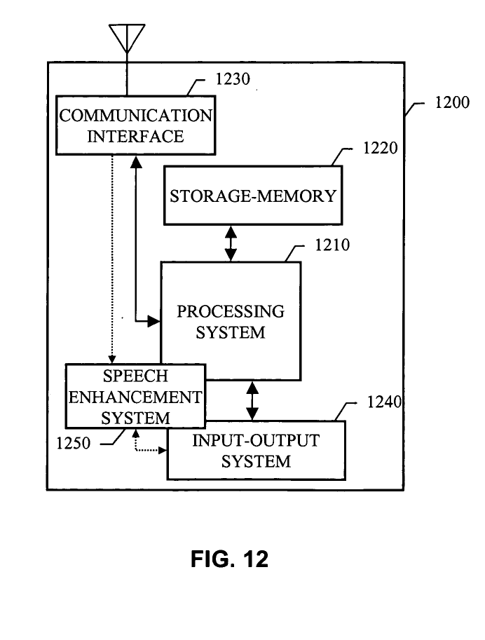

FIG. 12 is a block diagram illustrating an example mobile data processing machine 1200 with speech enhancement. The machine 1200 includes a processing system 1210, which may be a central processor that executes programs, performs data manipulations and controls tasks in the system 1200. The processing system 1210 may include multiple processors, processing units, and/or dedicated digital signal processing circuitry (e.g., one or more digital signal processors (DSPs)). The processing system 1210 may be housed in a single chip (e.g., a microprocessor or microcontroller) or in multiple chips using one or more printed circuit boards or alternative inter-processor communication links (i.e., two or more discrete processors making up a multiple processor system). The machine 1200 may further include one or more communication busses used to interconnect the processing system 1210 and other components of the machine 1200.

The machine 1200 may include storage-memory 1220. The storage-memory 1220 may be one or more units that can preserve data in a machine-readable medium within the machine 1200. The storage-memory 1220 may include a storage device (e.g., a disk drive), which may include a magnetic-based, optical-based or magneto-optical-based medium. The storage-memory 1220 may include volatile and/or non-volatile memory (e.g., electrically erasable programmable read-only memory (EEPROM) or flash memory), which may include a semiconductor-based medium.

The machine 1200 may include a communication interface 1230, which may include a transceiver, such as a radio transceiver. The communication interface 1230 allows information (e.g., digital information) to be transferred between the machine 1200 and external devices, networks or information sources. The machine 1200 may also include an input-output system 1240, which may include both audio and video input and output capabilities. The machine 1200 may be a cellular telephone, a personal digital assistant (PDA), a laptop, a digital video camera, etc.

The machine 1200 includes a speech enhancement system 1250 that implements speech enhancement techniques described herein. The speech enhancement system 1250 may include hardware and/or software components. The speech enhancement system 1250 may stand alone or may be integrated into the processing system 1210 and/or into the input-output system 1240. The speech enhancement system 1250 may operate on input audio information from the communication interface 1230 and/or on input audio information from an input sub-system in the input-output system 1240, as shown. The input audio information may include analog or digital audio signals, and the speech enhancement system 1250 may use analog or digital signal processing techniques.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more programs that are executable and/or interpretable on a programmable system including at least one programmable processor, which may be special or general purpose, coupled to receive data and/or instructions from, and to transmit data and/or instructions to, a storage-memory, at least one input device, and at least one output device.

These programs (also known as computer programs, software, software applications or code) include machine instructions for a programmable processor, and may be implemented in a high-level procedural and/or object-oriented programming language, and/or in assembly/machine language. As used herein, the term “machine-readable medium” refers to any software product, computer program product, apparatus and/or device (e.g., magnetic-based storage, optical-based storage, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The logic flow depicted in FIGS. 3-4 and 7-10 does not require the particular order shown. Other embodiments may be within the scope of the following claims.

1. An article comprising a machine-readable medium embodying information indicative of instructions that when performed by one or more machines result in operations comprising:
determining a speech-presence-uncertainty metric based on input representing audio information; and
performing smoothing during noise suppression of the input information based on the determined speech-presence-uncertainty metric to produce output representing audio information with enhanced speech and reduced musical noise.

2. The article of claim 1, wherein determining the speech-presence-uncertainty metric comprises:
determining a speech presence likelihood based on the input information and filter coefficients from a noise suppressor system; and
setting the speech-presence-uncertainty metric based on the determined speech presence likelihood.

3. The article of claim 2, wherein performing smoothing during noise suppression comprises:
low-pass filtering the filter coefficients from the noise suppressor system based on the speech-presence-uncertainty metric; and
suppressing noise in the input information based on the filtered filter coefficients.

4. The article of claim 3, wherein setting the speech-presence-uncertainty metric comprises:
determining a smoothed speech presence likelihood based on the determined speech presence likelihood and a past smoothed speech presence likelihood; and
setting the speech-presence-uncertainty metric based on the determined smoothed speech presence likelihood.

5. The article of claim 3, wherein the speech-presence-uncertainty metric comprises a Boolean value, low-pass filtering comprises selectively low-pass filtering the filter coefficients based on the Boolean value, and suppressing the noise comprises suppressing the noise based on the selectively filtered filter coefficients.

6. The article of claim 3, wherein determining the speech presence likelihood comprises determining the speech presence likelihood based on transformed information, suppressing the noise comprises suppressing the noise based on the transformed information, and the operations further comprises:
performing a time to frequency transform on the input information; and
generating the output information by performing an inverse time to frequency transform on the noise suppressed information.

7. The article of claim 3, wherein the speech-presence-uncertainty metric comprises a continuous value and low-pass filtering the filter coefficients comprises variably low-pass filtering based on the speech-presence-uncertainty metric to effect a varying amount of smoothing.

8. The article of claim 3, wherein the filter coefficients comprise filter coefficients formulated as a component-wise multiplication of a noisy speech spectrum in a frequency domain.

9. The article of claim 1, wherein determining the speech-presence-uncertainty metric comprises determining the speech-presence-uncertainty metric based on a full band minimum mean square error estimator weighting of the audio input.

10. A method comprising:
determining a speech-presence-uncertainty metric based on input representing audio information; and
performing smoothing during noise suppression of the input information based on the determined speech-presence-uncertainty metric to produce output representing audio information with enhanced speech and reduced musical noise.

11. The method of claim 10, wherein determining the speech-presence-uncertainty metric comprises:
determining a speech presence likelihood based on the input information and filter coefficients from a noise suppressor system;
determining a smoothed speech presence likelihood based on the determined speech presence likelihood and a past smoothed speech presence likelihood; and
setting the speech-presence-uncertainty metric based on the determined smoothed speech presence likelihood.

12. The method of claim 11, wherein performing smoothing during noise suppression comprises:
low-pass filtering the filter coefficients from the noise suppressor system based on the speech-presence-uncertainty metric; and
suppressing noise in the input information based on the filtered filter coefficients.

13. The method of claim 12, wherein determining the speech presence likelihood comprises determining the speech presence likelihood based on transformed information, suppressing the noise comprises suppressing the noise based on the transformed information, and the method further comprises:
performing a time to frequency transform on the input information; and
generating the output information by performing an inverse time to frequency transform on the noise suppressed information.

14. The method of claim 13, wherein the filter coefficients comprise filter coefficients formulated as a component-wise multiplication of a noisy speech spectrum in a frequency domain.

15. The method of claim 10, wherein determining the speech-presence-uncertainty metric comprises determining the speech-presence-uncertainty metric based on a full band minimum mean square error estimator weighting of the audio input.

16. A system comprising:
a noise suppressor system that receives input representing audio information and generates filter coefficients; and
a back-end smoothing system that receives the input information and the filter coefficients, determines a speech-presence-uncertainty metric based on the input information and the filter coefficients, and performs smoothing during noise suppression of the input information based on the determined speech-presence-uncertainty metric to produce output representing audio information with enhanced speech and reduced musical noise.

17. The system of claim 16, wherein the noise suppressor system comprises a minimum mean square error estimator, and the filter coefficients comprise filter coefficients formulated as a component-wise multiplication of a noisy speech spectrum in a frequency domain.

18. The system of claim 17, wherein the speech-presence-uncertainty metric is based on a full band minimum mean square error estimator weighting.

19. The system of claim 18, further comprising:
a communication interface;
an input-output system; and
a processing system coupled with the communication interface and the input-output system.

20. The system of claim 19, wherein the noise suppressor system and the back-end smoothing system are integrated with the processing system.

21. The system of claim 19, wherein the noise suppressor system and the back-end smoothing system are integrated with the input-output system.

22. The system of claim 19, wherein the input information is received from the input-output system.

23. An apparatus comprising:
speech presence uncertainty assessment circuitry coupled to receive input representing audio information and noise reduction filter coefficients, wherein the speech presence uncertainty assessment circuitry determines a speech-presence-uncertainty metric based on the input audio information and the noise reduction filter coefficients; and
smoothing circuitry comprising a filter and a multiplier unit, the filter coupled to receive the noise reduction filter coefficients, and the multiplier unit coupled to receive the input audio information and output smoothed filter coefficients from the filter.

24. The apparatus of claim 23, wherein the speech-presence-uncertainty metric is based on a full band minimum mean square error estimator weighting.

25. The apparatus of claim 24, wherein the noise reduction filter coefficients comprise filter coefficients formulated as a component-wise multiplication of a noisy speech spectrum in a frequency domain.

26. The apparatus of claim 25, further comprising a time to frequency unit coupled to receive speech data and transform the speech data into the input information, and a frequency to time unit coupled with the multiplier unit to transform the multiplier unit's output to generate enhanced speech data output with reduced musical noise.

27. The apparatus of claim 26, wherein the filter comprises a low-pass filter.

28. The apparatus of claim 27, wherein the low-pass filter comprises an FFT/IFFT filter.

29. A system comprising:
means for suppressing noise in input representing audio information based on filter coefficients; and
speech-presence-uncertainty-assessment means for driving smoothing of the filter coefficients used by the means for suppressing noise to reduce musical noise and enhance speech.

30. The system of claim 29, further comprising means for smoothing the filter coefficients.

31. The system of claim 30, wherein the means for suppressing noise comprises a minimum mean square error estimator.
